(19) United States
(12) Patent Application Publication
(10) Pub. No.: US 2017/0159430 A1
(43) Pub. Date: Jun. 8, 2017

(54) WELLBORE FLUID ANALYSIS

(71) Applicant: SCHLUMBERGER TECHNOLOGY CORPORATION, Sugar Land, TX (US)

(72) Inventors: Ronald E.G. van Hal, Cambridge, MA (US); Victoria Lee, Cambridge, MA (US); Andrew J. Speck, Milton, MA (US)

(21) Appl. No.: 14/958,257

(22) Filed: Dec. 3, 2015

(51) Int. Cl. E21B 49/08; G01V 8/14; G01V 8/16

(52) U.S. Cl. CPC E21B 49/081; G01V 8/16; G01V 8/14; E21B 2049/085

(57) ABSTRACT

Wellbore fluid analysis is provided. In some implementation, a fluid analysis apparatus includes a transparent chip with an inlet configured to accept a sample of a wellbore fluid, and a flow channel allowing the wellbore fluid to come into contact with a reagent. The fluid analysis apparatus also includes two partially transmissible mirrors positioned on opposing sides of the flow channel forming an optical cavity. In another implementation, a downhole tool includes a fluid analysis apparatus with a partially transparent chip having a flow channel allowing a wellbore fluid to come into contact with a reagent. The fluid analysis apparatus also includes a measurement system that can be used in conjunction with broadband cavity enhanced absorption spectroscopy.

### BACKGROUND

Data gleaned from chemical analysis of wellbore fluids associated with an underground formation, including data regarding concentration levels of corrosion causing compounds such as CO₂ and H₂S in the wellbore fluids, can be helpful in a variety of pursuits including assessing well completion and production strategies, and evaluating hydrocarbon reserves in a reservoir.

Conventionally, such analysis is carried out at a surface laboratory. This means that after wellbore fluid samples are collected in a wellbore and brought to the surface, they are then sent to a laboratory, which may take a considerable amount of time.

In many instances, the process of collecting wellbore fluid samples and sending them to a surface laboratory for analysis can lead to poor and inaccurate results. One of the reasons for this is the tendency of compounds (such as, for example, H₂S) in wellbore fluid samples to react with containers in which the wellbore fluid samples are collected and transported.

The above descriptions and examples are not admitted to be prior art by virtue of their inclusion in this section.

### SUMMARY

Wellbore fluid analysis is provided. In some implementations, a fluid analysis apparatus includes a transparent chip with an inlet configured to accept a sample of a wellbore fluid, and a flow channel allowing the wellbore fluid to come into contact with a reagent. The fluid analysis apparatus also includes two partially transmissible mirrors positioned on opposing sides of the flow channel forming an optical cavity.

In some implementations, a downhole tool includes a fluid analysis apparatus with a partially transparent chip having a flow channel allowing a wellbore fluid to come into contact with a reagent. The fluid analysis apparatus also includes a measurement system that can be used in conjunction with broadband cavity enhanced absorption spectroscopy.

In some implementations, a downhole tool includes a fluid analysis apparatus having a transparent microfluidic chip. The chip includes an inlet to accept a wellbore fluid sample and a flow channel to allow the wellbore fluid sample to come into contact with a reagent. The fluid analysis apparatus also has a measurement system formed with two partially transmissible mirrors positioned on opposing sides of the flow channel. The measurement system can be used in broadband cavity enhanced absorption spectroscopy.

This summary is not intended to identify key or essential features of the claimed subject matter, nor is it intended to be used as an aid in limiting the scope of the claimed subject matter.

Further features and aspects of example embodiments of the present invention are described in more detail below with reference to the appended Figures.

### BRIEF DESCRIPTION OF THE DRAWINGS

Features and advantages of the described implementations can be more readily understood by reference to the following description taken in conjunction with the accompanying drawings.

FIG. 1 illustrates an example wellsite and tool in accordance with various embodiments of wellbore fluid analysis;

FIG. 2 illustrates an example fluid analysis apparatus that can be used in accordance with various implementations of wellbore fluid analysis;

FIG. 3 illustrates an example fluid analysis apparatus including multiple measurement systems in accordance with implementations of wellbore fluid analysis;

FIG. 4 illustrates an example measurement system in accordance with implementations of wellbore fluid analysis;

FIG. 5 illustrates an example fluid analysis apparatus in accordance with implementations of wellbore fluid analysis;

FIG. 6 illustrates an example measurement system in which an optical waveguide is formed in accordance with implementations of wellbore fluid analysis;

FIG. 7 illustrates an example measurement system utilizing an optical waveguide in accordance with implementations of wellbore fluid analysis; and

FIG. 8 illustrates an example computing device which can be used in conjunction with various embodiments of wellbore fluid analysis.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

Additionally, some examples discussed herein involve technologies associated with the oilfield services industry. It will be understood however that the techniques of wellbore fluid analysis may also be useful in a wide range of other industries outside of the oilfield services sector, including for example, mining, geological surveying, etc.

As described herein, various techniques and technologies associated with wellbore fluid analysis can be used to detect one or more chemical components in a wellbore fluid after a chemical reaction has occurred. In some implementations, an optical cavity is employed along with a two-phase flow regime used as a mixing system. Moreover, in one possible aspect, the optical cell and the mixing system can be integrated on a single chip.

### Example Wellsite

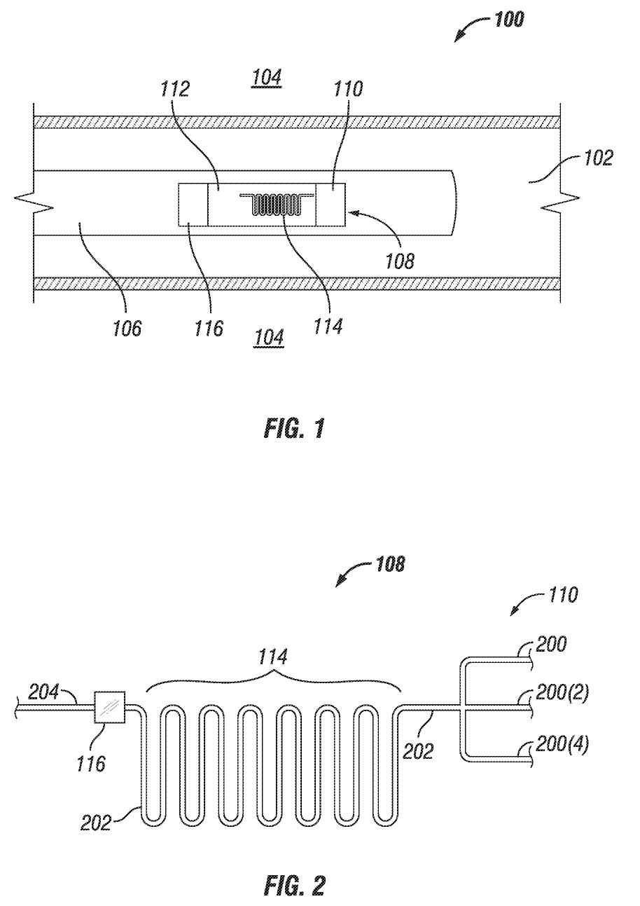

FIG. 1 illustrates an example of a wellsite 100 in which embodiments of wellbore fluid analysis can be employed. Wellsite 100 can be onshore or offshore and include a borehole 102 formed in a subsurface formation 104 by drilling in a manner that is well known, including, for example, directional drilling. Wellbore 102 can be horizontal, vertical, diagonal, or any combination thereof. Moreover, wellbore 102 can be cased, open, or any combination thereof.

A downhole tool 106 can be suspended within borehole 102 and include a fluid analysis apparatus 108. Downhole tool 106 can include any tool used in a subterranean environment including, but not limited to, a wireline tool, a logging tool, a logging-while-drilling tool, a measuring-while-drilling tool, an imaging tool, an acoustic tool, a permanent monitoring tool, a combination tool, etc.

In some implementations, fluid analysis apparatus 108 may include an injection system 110 configured to introduce at least a first fluid, such as a reagent, and a second fluid, such as a wellbore fluid, into a mixing system 112, in which at least one fluid is intermittent. In some implementations, mixing system 112 can have a channel structure 114, such as, for example, a capillary structure, which may be arranged in a serpentine or any other pattern known in the art. Fluid analysis apparatus 108 can also include a measurement system 116 which may be used to determine the rate or amount of mass transfer with respect to a given chemical constituent. For example, measurement system 116 may be used to measure an amount of a chemical constituent transferred from the second fluid to the first fluid during the mixing process occurring as the fluids flow along channel structure 114. Measurement system 116 can transmit measurements and other data to a surface of wellsite 100 in any manner known in the art, including, for example, through use of wired and/or wireless technologies. In some implementations, measurement system 116 can comprise an optical measurement system.

In some implementations, two-phase flow can be induced in channel structure 114 and be referred to as slug flow. In one possible aspect, slug flow in channels, such as for example, micro-channels, in channel structure 114 can provide thorough mixing of, and heat transfer between, the first and second fluids.

In some embodiments, the first fluid and the second fluid can be introduced into channel structure 114 in such a manner that slugs of the second fluid are formed, separated by the first fluid. For instance, when a reagent is chosen that is immiscible in a wellbore fluid being tested, slugs such as gas bubbles and/or oil droplets can form in the reagent. Depending on the application, the first fluid and the second fluid may comprise a liquid and a gas (respectively), two liquids, such as two partially miscible or immiscible liquids, etc.

Example System(s) and/or Technique(s)

FIG. 2 illustrates an example fluid analysis apparatus 108 in accordance with implementations of wellbore fluid analysis. As illustrated, a variety of fluids, such as wellbore fluids, one or more reagents, etc., can be accepted in a plurality of inputs 200 in fluid analysis apparatus 108. Though three inputs 200 are illustrated in FIG. 2, it will be understood that more or less inputs 200 may also be used.

Fluids can be accepted into inputs 200 using any known techniques in the art. For example, in some implementations, reagents can be provided by one or more vessels coupled to the inputs 200. The vessels can include cylinders or any other containers known in the art, and the reagents in the vessels can be induced to enter inlets 200 through pressurization (such as, for example, by exposure to pressures in wellbore 102) and/or through pumping, such as via a pump on tool 106. In one possible aspect, fluids can be injected into inlets 200 through use of one or more needles such that a constant flow of droplets of wellbore fluid can be included in a flow of reagent.

The reagents can include any reagents known in the art, and can be chosen based on their ability to chemically react with a fluid to be tested. In various portions of this disclosure, the fluid to be tested may be referred to as a wellbore fluid introduced to fluid analysis apparatus 108 (such as a wellbore fluid from wellbore 102), though it will be understood that the fluid to be tested can include any fluid of interest.

In some implementations, reagents may be chosen based on their ability to detect a variety of compounds, elements, properties, etc., of a fluid to be tested. These can include, for example, H₂S content, CO₂ content, acid number, pH, etc. In one possible aspect, a chemical reaction can occur between the reagent and the fluid, indicating one or more aspects of the makeup of the fluid being tested.

In some implementations, different inlets 200 can be used for different reagents such that multiple runs with various reagents can be conducted at different times in fluid analysis apparatus 108. For example, a run with one type of reagent entering through inlet 200 can be conducted, and measurements taken, then another run can be conducted with a different reagent introduced to fluid analysis apparatus 108 via a different inlet 200(4), for example. Measurements from the first and second runs can then be combined to get an improved perspective regarding the makeup of the fluid being tested in fluid analysis apparatus 108.

In some embodiments, once a reagent and a wellbore fluid are accepted into fluid analysis apparatus 108 via inlets 200, they merge into a single flow channel 202 where they are placed in contact with one another. The two fluids then flow through the length of channel structure 114 where they are mixed before arriving at an outlet 204, where the fluids can be, for example, ejected back into the wellbore 102, placed in a waste vessel, or otherwise discarded.

In some embodiments, at least some reagent can be stored in one or more storage areas on a chip on which all or part of fluid analysis apparatus 108 is integrated. In such implementations, the one or more storage areas on the chip can be in fluid contact with flow channel 202, such that the reagent from the one or more storage areas can be placed in contact with the wellbore fluid in the flow channel 202.

Flow channel 202 can have any length known in the art. In some implementations, the length of flow channel 202 can be engineered to allow a desirable level of mass transfer to occur between the reagent and a wellbore fluid. For example, in instances where mass transfer happens quickly, flow channel 202 can have a short length, including under 1 centimeter. In other instances, for example where mass transfer may take more time, flow channel 202 may have a length greater than 1 centimeter (including up to several centimeters and more). Flow channel 202 can also have any cross section known in the art, including trapezoidal, square, rectangular, curved (such as round, oval, etc.), and any combination thereof.

One or more of the fluids entering fluid analysis apparatus 108 can be filtered before reaching inlets 200. For instance, before wellbore fluid is allowed to enter inlet 200(2) for instance, a filter in the flowline of tool 106 can filter out undesired particles in the wellbore fluid.

In some implementations, mass transfer can occur between the wellbore fluid and the reagent without an emulsion being formed as the two fluids travel through flow channel 202. This can happen, for example, when the wellbore fluid and the reagent are partially miscible or immiscible, such that a two-phase flow is formed. In one possible aspect, a flow regime such as this can be controlled using properties of, for example, the two fluids, flow conditions, and/or the geometry of flow channel 202.

When slug flow or segmented flow occurs, the flow can be characterized by alternating segments of the two fluids. For instance, the reagent can be in the continuous phase, wetting the walls of flow channel 202, while the wellbore fluid can form “bubbles” or slugs separated from the walls of the flow channel 202 by a thin layer of the reagent.

In some implementations, slug flow (sometimes called Taylor flow) can increase a mass transfer rate between the wellbore fluid and the reagent. Slug flow can be characterized by the movement of alternating slugs of two immiscible fluids. For instance, a gas bubble length can be several times longer than a diameter of flow channel 202, and the gas bubble diameter can almost equal to the diameter of flow channel 202 such that just a thin liquid film of the reagent separates the wellbore fluid from the wall of the flow channel 202. In some embodiments, internal circulation in the liquid slugs of reagent can enhance the mass transfer at the interface of the reagent and the wellbore fluid.

In some implementations, before reaching outlet 204, the fluids can pass through measurement system 116 where various properties of one or both of the two fluids can be observed and measured. For example, changes in the reagent, such as, for example, color, transmissivity of light, etc., can be examined. In one possible aspect, these measurements can be used to assess the makeup of the well fluid that has reacted with the reagent along flow channel 202.

Measurement system 116 can include any measuring technology known in the art including, for example, optical technology capable of utilizing cavity enhanced absorption spectroscopy to enhance optical absorption of the reacted component (such as for example, a component in the wellbore fluid reacting with the reagent). In addition (or as an alternative in some examples) to being placed near outlet 204, Measurement system 116 can be placed anywhere along flow channel 202. Moreover, more than one measurement system 116 can be placed along flow channel 202. Additionally, one or more measurement systems 116 can also be placed at the inlets 200.

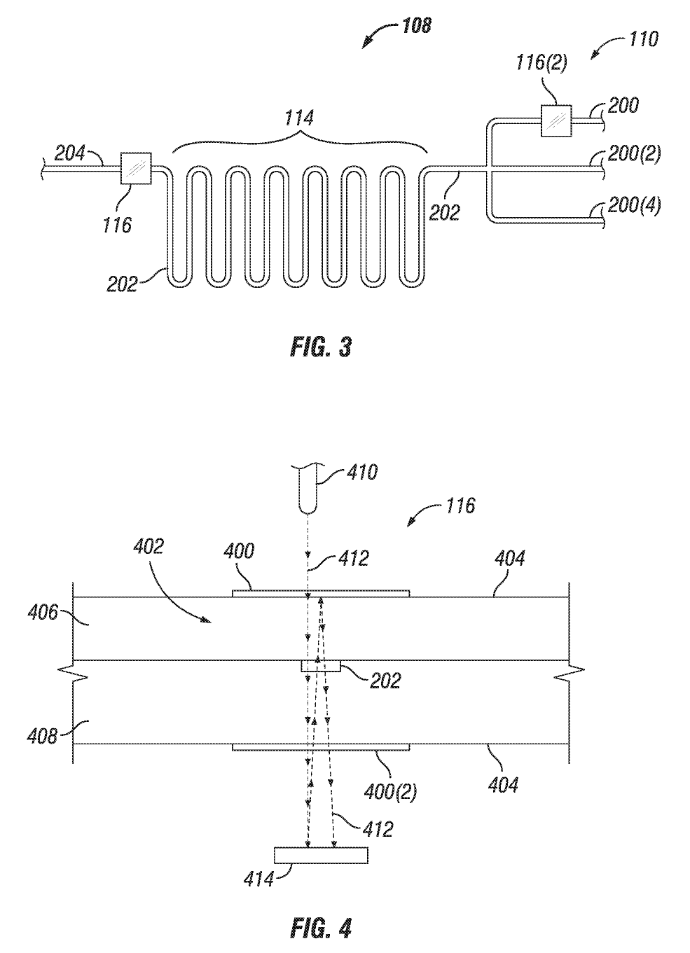

FIG. 3 illustrates an example fluid analysis apparatus 108 including multiple measurement systems 116 in accordance with implementations of wellbore fluid analysis. As illustrated, in addition to one or more measurement systems 116 located along flow channel 202, a second measurement system 116(2) is located at an inlet 200. In this way, baseline measurements of a fluid, such as a reagent, entering flow channel 202 can be measured before the fluid comes into contact with another fluid in flow channel 202. In some embodiments, baseline measurements of reagent taken in this manner can be compared with later measurements of the reagent taken at the measurement system 116 in flow channel 202 to form a more accurate appraisal of the amount of mass transfer that has occurred between the reagent and a wellbore fluid in flow channel 202.

In some implementations, an additional measurement system 116(2) can be located at an empty inlet 200 clear of any reagent and/or wellbore fluids. Reference measurements taken at such an additional measurement system 116(2) can be used to, for example: (1) compensate for fluctuations in an output signal from a light source used in conjunction with measurement system 116 and/or (2) compensate for any background signal of the unreacted reagent.

For example, in one possible aspect, reference measurements taken at measurement system 116(2) can be done in parallel with measurements taken by measurement system 116 on a reacted reagent in channel 202 and/or with measurements taken by another measurement system 116(2) on an unreacted reagent in another inlet 200. In some embodiments, the light from the light source can be split with any kind of optical splitter known in the art (such as, for example, a beam splitter) into two or more beams such that all of the measurement systems 116 in fluid analysis apparatus 108 receive light from the same light source. In this way, the reacted reagent in flow channel 202 and the unreacted reagent in the other inlet 200 can both be measured and optical variations can be accounted for.

In another possible aspect, an optical splitter can be used to split light from a light source, such that measurement system 116 at flow channel 202 and measurement system 116(2) at an inlet 200, which is filled with unreacted reagent, both receive light from the light source. In such a manner, fluctuations in an output signal from the light source can be compensated for in measurements taken by measurement system 116 at flow channel 202. Additionally, such a setup can also be used to compensate for any background signal of the unreacted reagent in the inlet 200.

Additional measurement systems 116(2) can be included on any and/or all of the inlets 200 such that baseline measurements of fluid flowing into the inlets 200 can be made. Moreover, the various measurement systems 116, 116(2) in fluid analysis apparatus 108 can be constructed in any manner known in the art. This includes having measurements systems 116 of different constructions at various locations in fluid analysis apparatus 108. For example, a measurement system 116 at inlet 200 can have a different configuration than a measurement system 116 in flow channel 202.

FIG. 4 illustrates an example measurement system 116 in accordance with implementations of wellbore fluid analysis. Measurement system 116 can include any system capable of measuring changes in a reagent in flow channel 202, and can include, for example, an optical cell such as illustrated in FIG. 4.

For example, flow channel 202 can be sandwiched between two partially transmissible mirrors 400, 400(2) creating an optical cavity 402. In some implementations, several sets of mirrors 400, 400(2) straddling flow channel 202 at various orientations may be included in measurement system 116.

Mirrors 400, 400(2) can be created using any process and/or materials known in the art (including, for example various coatings and/or thin films), and can have any configuration known in the art (such as, for example, flat, convex, concave, or any combination thereof). Mirrors 400, 400(2) can also have any level of transmissibility desired.

In some implementations, one or more of mirrors 400, 400(2) can be a freestanding component added to fluid analysis apparatus 108. Alternately, or additionally, one or more of mirrors 400, 400(2) can be integrated on a chip 404 in which at least part of flow channel 202 is formed. In one possible aspect, mirrors 400, 400(2) integrated on chip 404 may be more stable under conditions of shock and vibration.

In addition to flow channel 202 and potentially also one or more of mirrors 400, 400(2), inlets 200 and outlet 204 can also be integrated on chip 404.

Chip 404 can be transparent to any degree desired in order to allow light to be transmitted though chip 404 to flow channel 202. Moreover, chip 404 can be fabricated of several parts. For example, in some implementations, chip 404 can include a cover chip 406 and a chip with channel 408. Chip 404 can be fabricated of any at least partially transparent materials known in the art, including, for example, glass, sapphire, polymer, quartz, spinel, transparent high strength ceramics (such as, for example aluminum oxynitride), etc.

In some implementations, integration of flow channel 202 and measurement system 116 on a single microfluidic chip 404 can overcome potential destabilization of slugs at an interface between flow channel 202 and measurement system 116, which might otherwise occur in a system in which a single microfluidic chip 404 is not used. Furthermore, the use of microfluidic circuitry, such as flow channel 202 in chip 404, can potentially enable the use of rectangular channels to enhance the stability of slug flow.

In one possible aspect, the diameter of flow channel 202 can be decreased to increase mass transfer between the reagent and wellbore fluid being tested in fluid analysis apparatus 108. This can potentially result in a lower optical absorption and thus a high detection limit when, for example, broadband cavity-enhanced absorption spectroscopy is utilized in measurement system 116. It will be understood that the term “diameter” as used herein, can be used with any shape. For example, noting that a diameter of a rectangular flow channel 202 can be decreased can mean that a cross-sectional area of the rectangular flow channel 202 can be decreased either by decreasing its width, depth, or any combination thereof.

Moreover, since slugs can be easily destabilized by changes in diameter, material and/or other irregularities in flow channel 202, having a more uniform flow channel 202 in chip 404 can avoid destabilization in which the two immiscible phases in the wellbore fluid and the reagent comingle, making optical absorption measurements in measurement system 116 difficult if not virtually impossible. Finally, a lower detection limit in the reagent can be affected by short path lengths in flow channel 202 causing less absorption following Beer's law.

Thus, by integrating one or more of the components of fluid analysis apparatus 108 on a single chip 404 a desired flow regime can be fostered improving the quality of measurements achieved in measurement system 116.

In some implementations, a light source 410 can emit light towards flow channel 202. Light source 410 can take any form known in the art (such as, for example, an optical fiber, a light emitting diode, a tungsten halogen lamp, a deuterium lamp, etc.) and can emit any form of light known in the art, including, for example, incoherent light. In one possible aspect, light source 410 can emit light with a wavelength of approximately 450 nanometers. In some instances, the type and/or wavelength of light emitted from light source 410 can be customized based on the type of reagent being used in fluid analysis apparatus 108. Light source 410 can be an external component or it can be integrated on chip 404.

In some embodiments, light 412 from light source 410 can pass though mirror 400, before passing through chip 404, flow channel 202 (including reagent in flow channel 202) and mirror 404(2) before being received at a detector 414. Alternately, or additionally, at least some of light 412 can be reflected from mirror 400(2) back through flow channel 202 before being reflected from mirror 400 back through flow channel 202. At least some of this reflected beam of light 412 can then pass through mirror 400(2) and be detected at detector 414. Further reflections of this type can continue allowing reflections of reflected beam of light 412 to pass through flow channel 202, and thus the reagent, more times before being collected at detector 414. In this manner, light 412 from light source 410 can pass through the reagent in flow channel 202 multiple times before being detected at detector 414, allowing for a more accurate measurement of one or more qualities of the reagent in flow channel 202.

In some implementations, one or more aspects of mirrors 400, 400(2) (such as, for example, their orientation, placement, structure, shape, etc.) can be customized to create more or less reflections, as desired, through the reagent before being detected at detector 414.

Detector 414 can take any form known in the art, including, for example a thermal detector and/or a silicon photodiode. In some implementations, the type of detector used to form detector 414 can be chosen on the basis of compatibility with the type of light being emitted from light source 410 and/or the type of reagent in flow channel 202. Also, detector 414 can be a separate external component, or it can be integrated on chip 404.

In some implementations, a second detector (not shown for the sake of graphic clarity) can be included behind mirror 400 to detect light reflected from mirror 400(2) which passes through mirror 400. Alternately, or additionally, a second light source 410 can be positioned behind mirror 400(2), such that its emissions can be detected at detector 414 and the second detector (if present).

Also, even though the discussion of measurement system 116 above was conducted in the context of light passing through flow channel 202, it will be understood that that same principles apply for measurement systems 116(2) at inlets 200. In such instances, light from light source 410 will pass through one of the inlets 200 (and the fluid flowing there through) rather than through flow channel 202 before being detected at detector 414.

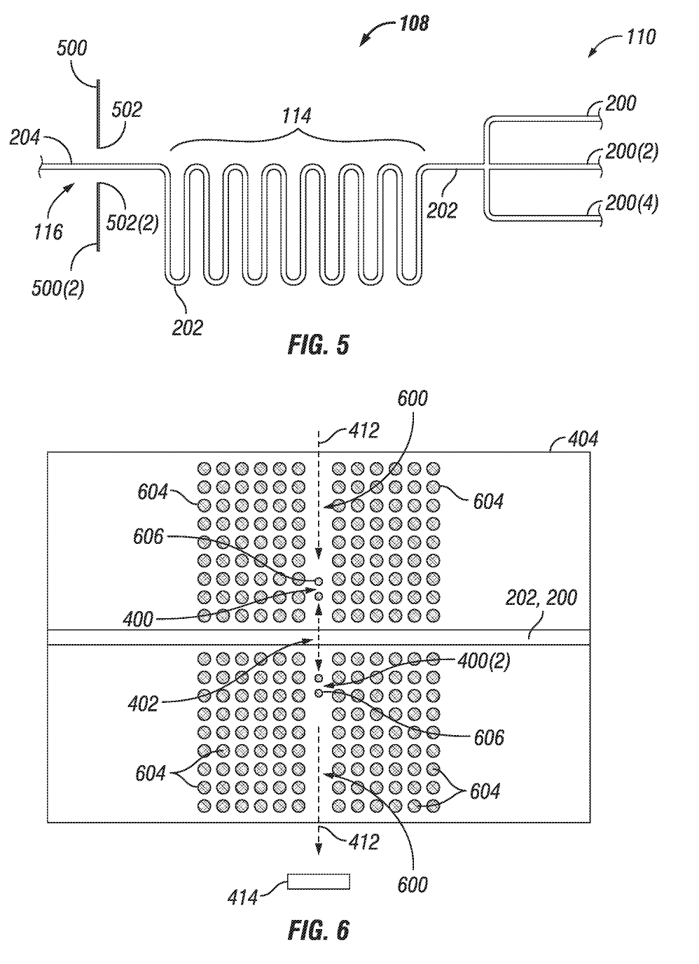

FIG. 5 illustrates an example fluid analysis apparatus 108 in which light source 410 comprises one or more optical fibers 500. In some implementations, optical fiber 500 acts as light source 410 by delivering light to measuring system 116 as discussed in conjunction with FIG. 4. The light from optical fiber 500 is passed through mirror 400 as discussed above, and at least some of the light is passed through mirror 400(2) after passing through the reagent in flow channel 202 (or an inlet 200) one or more times. After passing through mirror 400(2), the light is detected by detector 414. In some implementations, detector 414 is located before optical fiber 500(2), such as when detector 414 is integrated in chip 404, for example. In some implementations, light passing through mirror 400(2) enters optical fiber 500(2), which then directs the light to detector 414.

In some such implementations, optical fibers 500, 500(2) and mirrors 400, 400(2) can be external components or optical fibers 500, 500(2) and mirrors 400, 400(2) can be integrated on chip 404, as desired.

In some implementations, one or more of mirrors 400, 400(2) can be created at ends 502, 502(2) of optical fibers 500, 500(2) using any techniques and/or materials known in the art. For example, in one possible aspect, one or more of ends 502, 502(2) can be polished, and/or at least partially coated with one or more coatings, to form partially transmissible mirrors 400, 400(2).

In operation, ends 502, 502(2) can operate similar to mirrors 400, 400(2) as discussed in conjunction with FIG. 4, allowing light from optical fiber 500 to pass through end 502, before passing through chip 404 and the reagent (in either flow channel 202 or inlet 200 depending on where measurement system 116 is in fluid analysis apparatus 108). Some of the light can be passed through end 502(2), while the rest can be reflected from end 502(2), with at least some light being reflected through the reagent, and off end 502 back towards end 502(2). In some implementations, light passing through end 502(2) can be guided through optical fiber to detector 414.

In some embodiments, one or more aspects of the ends 502, 502(2) (such as, for example, their orientation, placement, structure, reflectivity, shape, etc.) can be customized to create more or less reflections, as desired, through the reagent before allowing light 412 to be passed through end 502(2) and be detected at detector 414.

Optical fibers 500, 500(2) and their respective ends 502, 502(2) can be external components or they can be integrated on chip 404, as desired.

Also, even though only one measuring system 116 is illustrated in FIG. 5, it will be understood that more measuring systems 116 can be present. This includes measuring systems 116(2) at one or more inlets 200 that can be used to calibrate for variations in light source 410 and/or any background signal of the reagent, as discussed above.

In addition to the above implementations, integration of optics onto chip 404 can also be obtained by integration of an optical wave guide on chip 404.

FIG. 6 illustrates an example measurement system 116 in which an optical waveguide 600 is formed on chip 404 in accordance with embodiments of wellbore fluid analysis. In some implementations, waveguide 600 is formed using a pair of materials on chip 404 with differing indexes of refraction such that light 412 from light source 410 is at least partially confined within the material with the higher index.

For example, in one possible aspect, a plurality of holes 604 including a material with a different index of refraction than the material used to create chip 404 are employed to confine light to the region between them. A small number of holes 606 within the waveguide can function as mirrors 400, 400(2). In some embodiments, holes 604 and/or holes 606 are filled with air.

Materials that can act as the substrate for chip 404 and the filling for holes 604 forming waveguide 600 can include, for example, silicon and silicon oxide, SU-8 and Polymethyl methacrylate (PMMA) polymers, along with many others. Waveguides 600 can be used to direct light 412 to optical cavity 402 formed across the microfluidic flow path, in either flow channel 202 or inlet 200, with mirrors 400, 400(2) being formed at ends of waveguide 600 or being integrated into waveguide 600 using, for example, Bragg reflectors formed from periodic index variations within waveguide 600.

Waveguide 600 and mirrors 400, 400(2) can be formed in any configuration known in the art in order to create a desired environment between mirrors 400, 400(2) such that at least some of light 412 is reflected as many times as desired through the microfluidic flow path before being led by waveguide 600 to detector 414.

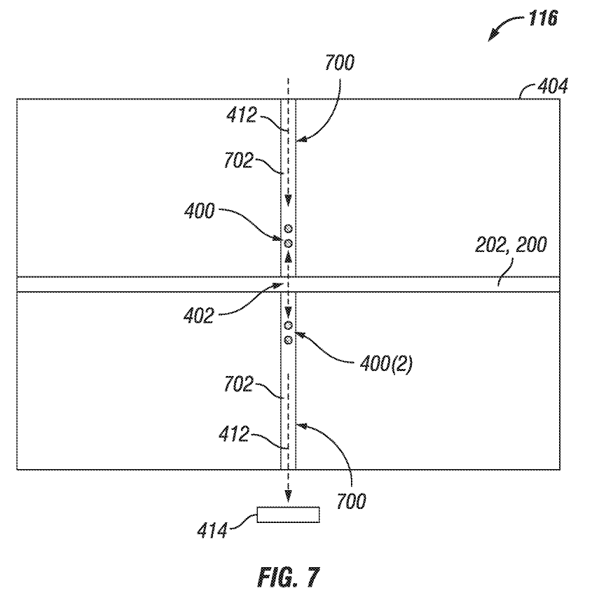

FIG. 7 illustrates an example measurement system 116 in which a waveguide 700 is constructed from a material 702 (such as photonic crystal resonators) with a higher index of refraction than the rest of chip 404 to at least partially confine light 412. In some implementations, a plurality of holes and/or slots within chip 404 can confine light 412 to waveguide 700. In one possible aspect, light 412 is at least partially confined within a slot in the substrate where reagent flows, such as flow channel 202 or inlet 200. A couple of holes in chip 404 and/or lines across waveguide 700 can function as mirrors 400, 400(2).

In some implementations, a photonic assembly comprising measurement system 116 in FIG. 7 can be fabricated using standard microfabrication techniques.

Moreover, in some embodiments, the free spectral range (FSR) of optical cavity 402 can be less than a resolution of detector 414 to ensure sensitivity of measurements at detector 414 eigenmodes of optical cavity 402. For instance, in some examples, the FSR (Δλ) can be given by:

Δλ=λ²/2nl

where λ is the measurement wavelength, n is the index of refraction of the reagent within flow channel 202 or inlet 200, and l is the length of optical cavity 402. In some implementations, for common aqueous reagents and measurement resolutions of 1 nanometer, a length of flow channel 202 or inlet 200 can be around, for example, 150 microns.

### Example Computing Device(s)

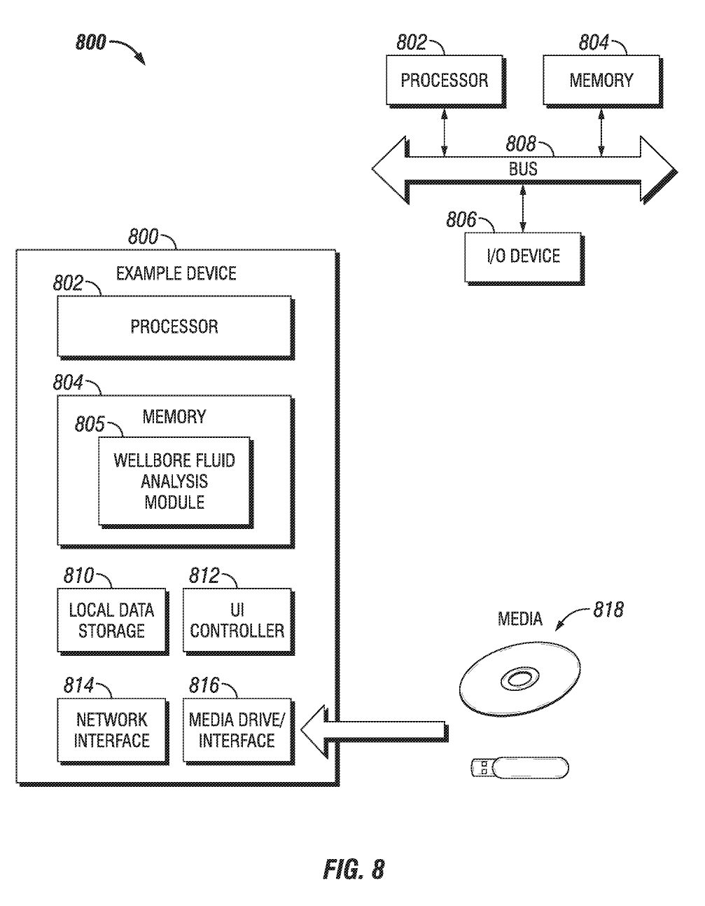

FIG. 8 illustrates an example device 800, with a processor 802 and memory 804 for hosting a wellbore fluid analysis module 806 configured to implement various embodiments of wellbore fluid analysis as discussed in this disclosure.

For example, wellbore fluid module 806 can be used to control the input of various fluids to inlets 200 (including, for example, the type and/or concentration of reagent and wellbore fluid being input to fluid analysis apparatus 108), the concentration and/or wavelength of light to light source 410, etc. Additionally, wellbore fluid analysis module 806 can be used to collect information from detector 414 and process it to determine the makeup of well fluids being analyzed in fluid analysis apparatus 108.

In some implementations, wellbore fluid module 806 can be used, at least in part, to calculate a concentration of analyte (i.e. a compound of interest) in a well fluid based on an optical absorbance of light by a reacted reagent as measured by a measurement system 116, and adjust a mixing ratio to more or less reagent in flow channel 202 in the event of respectively higher and lower concentrations of analyte.

Memory 804 can also host one or more databases and can include one or more forms of volatile data storage media such as random access memory (RAM), and/or one or more forms of nonvolatile storage media (such as read-only memory (ROM), flash memory, and so forth).

Device 800 is one example of a computing device or programmable device, and is not intended to suggest any limitation as to scope of use or functionality of device 800 and/or its possible architectures. For example, device 800 can comprise one or more computing devices, programmable logic controllers (PLCs), etc.

Further, device 800 should not be interpreted as having any dependency relating to one or a combination of components illustrated in device 800. For example, device 800 may include one or more of a computer, such as a laptop computer, a desktop computer, a mainframe computer, etc., or any combination or accumulation thereof.

Device 800 can also include a bus 808 configured to allow various components and devices, such as processors 802, memory 804, and local data storage 810, among other components, to communicate with each other.

Bus 808 can include one or more of any of several types of bus structures, including a memory bus or memory controller, a peripheral bus, an accelerated graphics port, and a processor or local bus using any of a variety of bus architectures. Bus 808 can also include wired and/or wireless buses.

Local data storage 810 can include fixed media (e.g., RAM, ROM, a fixed hard drive, etc.) as well as removable media (e.g., a flash memory drive, a removable hard drive, optical disks, magnetic disks, and so forth).

One or more input/output (I/O) device(s) 812 may also communicate via a user interface (UI) controller 814, which may connect with I/O device(s) 812 either directly or through bus 808.

In some implementations, a network interface 816 may communicate outside of device 800 via a connected network, and in some implementations may communicate with hardware, such as tool 106, etc.

In some embodiments, tool 106 may communicate with device 800 as input/output device(s) 812 via bus 808, such as via a USB port, for example.

A media drive/interface 818 can accept removable tangible media 820, such as flash drives, optical disks, removable hard drives, software products, etc. In some implementations, logic, computing instructions, and/or software programs comprising elements of wellbore fluid analysis module 806 may reside on removable media 820 readable by media drive/interface 818.

In some embodiments, input/output device(s) 812 can allow a user to enter commands and information to device 800, and also allow information to be presented to the user and/or other components or devices. Examples of input device(s) 812 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes of wellbore fluid analysis module 206 may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

In some implementations, device 800, or a plurality thereof, can be employed at wellsite 100. This can include, for example, in various equipment, such as tool 106, and in various surface equipment, such as a logging and control system, etc.

Although a few example embodiments have been described in detail above, those skilled in the art will readily appreciate that many modifications are possible in the example embodiments without materially departing from this disclosure. Accordingly, such modifications are intended to be included within the scope of this disclosure as defined in the following claims. Moreover, embodiments may be performed in the absence of any component not explicitly described herein.

As used in the description and claims, phrases in the form of “at least one of [a] and [b]” should be construed as being disjunctive. For example, the recitation of “at least one of [a], [b], and [c]” should be understood to encompass: arrangements that include [a] but neither [b] nor [c]; arrangements that include [b] but neither [a] nor [c]; arrangements that include [c] but neither [a] nor [b]; arrangements that include [a] and [b] but not [c]; arrangements that include [a] and [c] but not [b]; arrangements that include [b] and [c] but not [a]; and arrangements that include [a], [b], and [c].

In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A fluid analysis apparatus comprising:
an at least partially transparent chip including:
an inlet configured to accept a sample of a wellbore fluid; and
a flow channel configured to allow the wellbore fluid sample to come into contact with a reagent; and
two at least partially transmissible mirrors positioned on opposing sides of the flow channel to form an optical cavity.

2. The fluid analysis apparatus of claim 1, wherein the at least partially transparent chip is made from one or more of:
glass;
sapphire;
polymer;
quartz;
spinel; and
a transparent high strength ceramic.

3. The fluid analysis apparatus of claim 1, wherein the at least partially transparent chip further comprises a storage area storing the reagent, wherein the storage area is in fluid contact with the flow channel.

4. The fluid analysis apparatus of claim 1, wherein at least a portion of the flow channel has a rectangular cross-section.

5. The fluid analysis apparatus of claim 1, wherein the two at least partially transmissible mirrors are integrated on the at least partially transparent chip.

6. The fluid analysis apparatus of claim 1, wherein the two at least partially transmissible mirrors are located proximate an outlet of the flow channel.

7. The fluid analysis apparatus of claim 1, wherein each of the two at least partially transmissible mirrors is fabricated on an end of a respective optical fiber.

8. The fluid analysis apparatus of claim 7, wherein the two at least partially transmissible mirrors and the respective optical fibers are integrated on the at least partially transparent chip.

9. The fluid analysis apparatus of claim 1, further comprising a second set of two at least partially transmissible mirrors on opposing sides of one of the two or more inlets configured to form a second optical cavity and allow a reference measurement to be made of the reagent before the reagent is placed into contact with the wellbore fluid.

10. The fluid analysis apparatus of claim 1, further comprising an optical waveguide integrated on the at least partially transparent chip, the optical waveguide being configured to direct light to the optical cavity.

11. A downhole tool including a fluid analysis apparatus comprising:
an at least partially transparent chip including a flow channel configured to allow a wellbore fluid to come into contact with a reagent; and
a measurement system configured for use in broadband cavity enhanced absorption spectroscopy.

12. The downhole tool of claim 1, wherein the at least partially transparent chip is a microfluidic chip.

13. The downhole tool of claim 1, wherein the measurement system is located proximate an outlet of the flow channel.

14. The downhole tool of claim 1, wherein the measurement system comprises:
two at least partially transmissible mirrors positioned on opposing sides of the flow channel.

15. The downhole tool of claim 14, wherein the two at least partially transmissible mirrors are integrated on the at least partially transparent chip.

16. The downhole tool of claim 14, wherein each of the two at least partially transmissible mirrors is fabricated on an end of a respective optical fiber.

17. The downhole tool of claim 11, wherein the measurement system comprises one or more photonic crystal resonators.

18. A downhole tool including a fluid analysis apparatus comprising:
an at least partially transparent microfluidic chip including:
an inlet configured to accept a wellbore fluid sample, and
a flow channel configured to allow the wellbore fluid sample to come into contact with a reagent; and
a measurement system including two at least partially transmissible mirrors positioned on opposing sides of the flow channel, wherein the measurement system is configured for use in broadband cavity enhanced absorption spectroscopy.

19. The downhole tool of claim 18, wherein the downhole tool is one or more of:
a wireline tool;
a logging-while-drilling tool; and
a measuring-while-drilling tool.

20. The downhole tool of claim 18, wherein the two at least partially transmissible mirrors are integrated on the at least partially transparent chip.
